(19) United States
(12) Patent Application Publication
(10) Pub. No.: US 2023/0303371 A1
(43) Pub. Date: Sep. 28, 2023

(54) INDUSTRIAL TRUCK COMPRISING A ROTARY STEERING DRIVE

(71) Applicant: HUBTEX MASCHINENBAU GMBH & CO. KG, FULDA (DE)

(72) Inventor: RABAN KNACKER, EHRENBERG-MELPERTS (DE)

(73) Assignee: HUBTEX MASCHINENBAU GMBH & CO. KG, FULDA (DE)

(21) Appl. No.: 18/034,065

(22) PCT Filed: Oct. 5, 2021
(86) PCT No.: PCT/EP2021/077430

§ 371 Date: Apr. 27, 2023

(30) Foreign Application Priority Data
Oct. 29, 2020 (DE) 10 2020 128 489.6

(51) Int. Cl. B66F 9/075; B66F 9/24; B66F 9/22

(52) U.S. Cl. CPC B66F 9/07568; B66F 9/22; B66F 9/24

(57) ABSTRACT

An industrial truck includes at least two steerable wheels, each of which is configured to be steerable independently of one another, and a steering angle control. Each of the at least two steerable wheels has assigned thereto one steering drive unit which comprises a rotary steering motor, and one steering shaft. Each one of the at least two steerable wheels is connected to the rotary steering motor of the steering drive unit via the steering shaft which is assigned thereto. The steering angle control controls each rotary steering motor. The steering angle control has at least one rotational angle detection device which detects a current rotational angle position of each steering shaft. The at least one rotational angle detection device is designed as a part of each steering drive unit.

### CROSS REFERENCE TO PRIOR APPLICATIONS

This application is a U.S. National Phase application under 35 U.S.C. § 371 of International Application No. PCT/EP2021/077430, filed on Oct. 5, 2021 and which claims benefit to German Patent Application No. 10 2020 128 489.6, filed on Oct. 29, 2020. The International Application was published in German on May 5, 2022 as WO 2022/089891 A1 under PCT Article 21(2).

### FIELD

The present invention relates to an industrial truck having at least two wheels which are steerable independently of one another, for example, having at least three wheels which are steerable independently of one another, wherein each of the steerable wheels is connected to a rotary steering motor of a steering drive unit via a steering shaft, and a steering angle control is provided for controlling the rotary steering motor, the steering angle control comprising a rotational angle detection device for detecting a current rotational angle position of the steering shaft.

### BACKGROUND

Industrial trucks of this kind and corresponding steering systems and methods for such industrial trucks have previously been described. In the case of such industrial trucks, for the purpose of steering the steerable wheels, the current actual rotational angle positions are typically first detected for each wheel via the rotational angle detection device with the positions being compared with a predetermined angle target value in a steering controller or a steering computer. A control signal corresponding to the initiation of a steering operation or a steering angle correction is subsequently output by the steering controller to the respective steering motor of the steerable wheel in order to perform a rotational or steering movement of the wheel. The steering motor can in this case in particular be part of a separately designed, compact steering drive unit. It should be clear that, in the present case, a steerable wheel is of course understood to mean a steerable wheel suspension or wheel arrangement, also having more than one single wheel, and in particular having twin wheels, such as a bogie having two individual wheels arranged thereon.

Various rotational angle detection devices for detecting the current rotational angle position of a steerable wheel have previously been described, which detection devices are arranged in particular on the free, usually upper, end of a wheel suspension shaft, such as a shaft having a bogie with a wheel attachment, or at the free end of an output shaft of a steering drive. The disadvantage is here in particular the relatively poor accessibility of such installation locations of the rotational angle detection device, as well as the necessary space requirement at locations of the vehicle which can advantageously have other uses, such as, in particular, in the region above the load wheels. Previous developments were therefore primarily directed towards the reduction in size and the minimization of such rotational angle detection devices. Such rotational angle detection devices are, however, relatively cost-intensive, both in manufacture and assembly. It has furthermore been found that, in the case of some vehicle superstructures and attachments, an undesired susceptibility to errors of the rotational angle detection devices can occur, which can in turn cause relatively high operating and maintenance costs for the reasons mentioned above, in particular due to poor accessibility.

### SUMMARY

An aspect of the present invention is to provide an industrial truck which mitigates at least one of the above-mentioned disadvantages, and in particular which allows for a particularly space-saving and low-cost rotational angle detection device.

In an embodiment, the present invention provides an industrial truck which includes at least two steerable wheels, each of which is configured to be steerable independently of one another, and a steering angle control. Each of the at least two steerable wheels has assigned thereto one steering drive unit which comprises a rotary steering motor, and one steering shaft. Each one of the at least two steerable wheels is connected to the rotary steering motor of the steering drive unit via the steering shaft which is assigned thereto. The steering angle control is configured to control each rotary steering motor. The steering angle control comprises at least one rotational angle detection device which is configured to detect a current rotational angle position of each steering shaft. The at least one rotational angle detection device is designed as a part of each steering drive unit.

### BRIEF DESCRIPTION OF THE DRAWINGS

The present invention is described in greater detail below on the basis of embodiments and of the drawings in which:

FIG. 1 shows an industrial truck according to the present invention;

FIG. 2 shows a detail view of a steerable load wheel of the industrial truck;

FIG. 3 shows a detail view of a steerable drive wheel of the industrial truck; and

FIG. 4 shows a detail view of the steering drive unit of the industrial truck.

### DETAILED DESCRIPTION

The present invention provides that the rotational angle detection device be designed as part (in particular as a structural or integral component) of the steering drive unit. The rotational angle detection device can thus be integrated into the steering drive unit so that the steering angle detection can take place directly in the steering drive, and in particular without further attachments. This in particular has the advantage that a separate installation space on a steering shaft above a bogie or outside the steering drive is not required, so that a vehicle chassis can therefore, for example, be designed to be particularly close to the ground or low-floor in the region of the load receiving wheels, so that goods can be inserted and removed, as well as transported, in a manner particularly close to the ground, and, as a result, the functional scope of the vehicle can be expanded and the operational reliability thereof increased. The steering drive unit, which is generally arranged laterally next to the steerable wheel and is freely accessible from below or to the side of the vehicle, furthermore allows for a particularly fast and easy-to-assemble accessibility, also for the rotational angle detection device. The steering drive unit can in particular be formed by an assembly comprising a steering drive housing, a motor part arranged therein (in particular, the steering motor) an output shaft, a bearing of the drive shaft, and the rotational angle detection device. The drive shaft may typically extend from the steering motor through a part of the steering drive housing and through an opening of the steering drive housing in the direction of the surroundings of the steering drive unit.

Each of the steerable wheels can, for example, be assigned a steering drive unit. The steering drive unit in this case serves to steer the correspondingly assigned wheel, and can have one or more rotational angle detection devices in each case. Each steerable wheel can consequently be steered via a separate steering drive unit and in particular via a separate steering motor. The steering drive units and/or steering motors can be structurally identical, so that the production and maintenance of the industrial truck can be particularly cost-effective.

In an embodiment of the present invention, the rotational angle detection device can, for example, be surrounded by the steering drive housing of the steering drive unit, and, can, for example, be completely surrounded. The rotational angle detection device can thereby be mounted on or from the industrial truck in a particularly simple manner, during manufacture or for maintenance purposes, together with the steering drive unit, in particular, the steering drive housing. At least a part of the rotational angle detection device can alternatively be fastened separately to the steering drive housing, and can in particular be replaceable without the need for disassembly of the housing.

The rotational angle detection device can, for example, comprise an encoder unit which is connected in a rotationally-fixed manner to the steering shaft, and a sensor unit functionally interacting with the encoder unit. The sensor unit can in particular be arranged so as to be fixed or stationary with respect to a chassis of the industrial truck, and can in particular be replaceable separately. This allows for a particularly reliable detection of the current rotational angle position of the steerable wheels. The rotational angle detection device can in principle be designed as a haptic, optical, magnetic, or radio-based system.

In an embodiment of the present invention, the rotational angle detection device can, for example, be designed to operate magnetically. The encoder unit can in this case have at least one magnetic encoder element, and the sensor unit can in this case have at least one magnetic field sensor for detecting a magnetic field generated by the at least one magnetic encoder element. The encoder unit can in particular be designed as a magnet ring, and in particular as a magnet ring surrounding the steering shaft. The magnet ring can, for example, be partially magnetized. The magnetic field sensor can be designed to operate reversibly, and to be replaceable in a particularly simple manner. Sensors of different security levels can in particular be interchanged. The manufacture and maintenance of the industrial truck can thereby be particularly cost-effective. The rotational angle detection device (in particular, the encoder element) and the sensor unit can in particular form a modular system in which components can be replaced according to individual specifications.

The rotational angle detection device can, for example, be arranged between the rotary steering motor and a fastening device (in particular, a fastening flange) of the steering drive unit. The rotational angle detection device can in particular be arranged between the rotary steering motor and a bearing of the output shaft, in particular, the output-side bearing. This provides a particularly space-saving and compact arrangement of the rotational angle detection device. A space provided in particular for the low-vibration mounting of the output shaft within the steering drive housing can, for example, be used effectively.

The steering shaft can have a steering shaft axis which corresponds to the steering axis or axis of rotation of the respective steerable wheel and/or the axis of a steering drive shaft of the steering drive unit. The first-mentioned variant can in particular be present when the axis of rotation of the steerable wheel substantially corresponds to the axis of rotation of the steering motor. In the case of the very much more frequently occurring second variant, the steering drive shaft can be formed by the output shaft of the steering motor (optionally arranged in parallel with the axis of rotation of the steerable wheel) or by a transmission shaft optionally arranged between the steering motor and the wheel. The axis of the steering drive shaft can thus correspond to the axis of rotation of the steering drive unit or the steering motor, but can in principle also be arranged at an angle thereto or in parallel therewith. In particular when a transmission is arranged between the steerable wheel and the steering drive unit, the steering shaft axis can be spaced apart from in parallel with or arranged at an angle to the steering axis of the respective steerable wheel.

The steering shaft can, for example, be formed by the output shaft of the steering drive unit. This provides a particularly reliable and exact detection of the current rotational angle position of the steerable wheels.

In an embodiment of the present invention, a transmission, for example, a transmission gearing, for example, an orbital-steering transmission gearing, can, for example, be arranged between the steering drive unit and the steered wheel. In such an embodiment, it has been found to be particularly advantageous if (for example, via the steering control) the transmission ratio of the transmission is taken into account when determining the actual current rotational angle position of the steered wheel. The transmission can in particular serve for approaching a desired rotational angle position in a particularly exact manner by the steerable wheels.

The rotary steering motor can be designed as a hydraulic motor, in particular as an orbital motor, or as an electric motor. In the case of a rotary steering motor designed as a hydraulic motor, the rotary steering motor can, for example, be arranged as part of an overall hydraulic system of the industrial truck.

The rotary steering motor can, for example, be arranged so as to be replaceable independently of the rotational angle detection device. It can in particular be provided that the motor part or the steering motor be arranged as a separate part in or on the steering drive housing. In the event of a defect of the steering motor, it can then be replaced without the rotational angle detection device so that maintenance costs can be particularly low.

An embodiment of the present invention is explained in greater detail below under reference to the drawings. Like reference signs thereby denote like components.

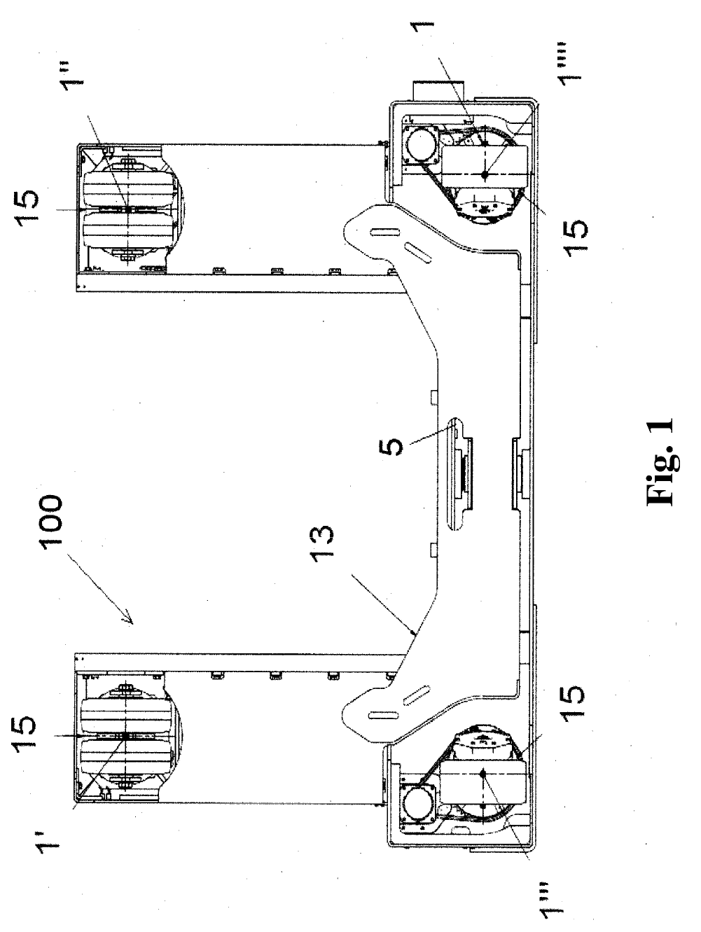

The industrial truck according to the present invention, which denoted by reference sign 100 in FIG. 1, shows by way of example and schematically a vehicle chassis 13 having steerable wheels 1 arranged thereon. Four steerable wheels 1 are provided in the present example, wherein each of the four steerable wheels 1 is designed to be steerable about a steering axis A1 at an unlimited angle. The expression “steerable at an unlimited angle” is intended to illustrate that a steering or rotation of the steerable wheel 1 over 360° is possible.

The industrial truck 100 thus comprises a first steerable wheel 1′, a second steerable wheel 1″, a third steerable wheel 1‴, and a fourth steerable wheel 1′‴. In the shown example, the steerable wheels 1′ and 1″ are arranged in a load-bearing region of the vehicle chassis 13 and are therefore also referred to as load wheels. The steerable wheels 1‴ and 1′‴ can be designed as drive wheels, each having a respective traction motor 14. All of the steerable wheels 1 in the example shown in FIG. 1 can be structurally identical, apart from the traction drive technology. The steerable wheels 1 in particular each comprise a bogie 15 having two individual wheels arranged thereon. The steerable wheel 1 can therefore also be referred to as a wheel assembly 1.

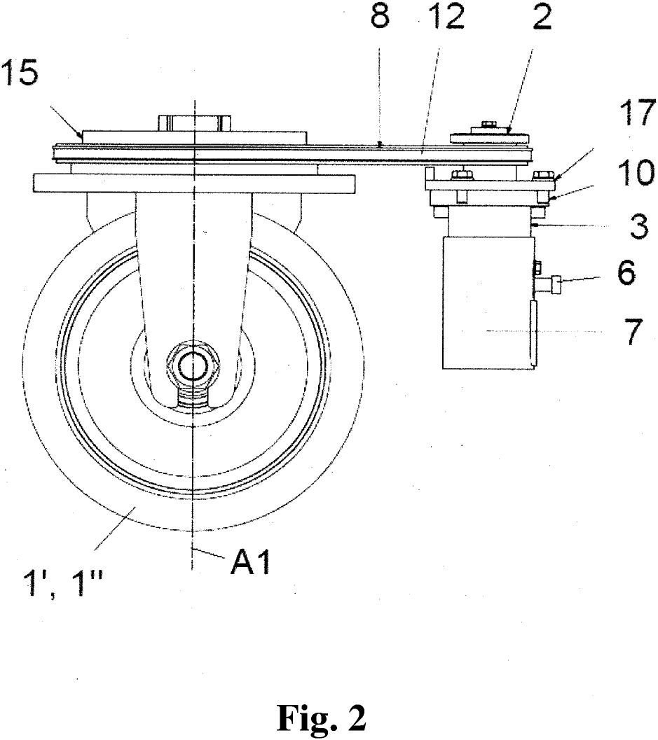

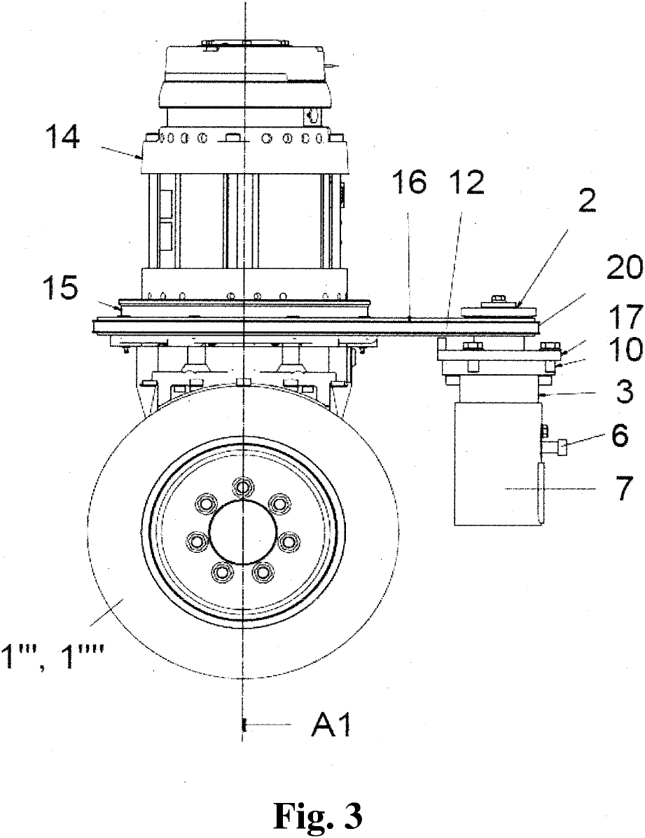

FIGS. 2 and 3 each show a steerable wheel 1 of the industrial truck 100 in a detail view. The wheel shown in FIG. 2 is designed as a load wheel 1′, 1″. The wheel shown in FIG. 3 is designed as a drive wheel 1‴, 1′‴.

In contrast to the wheel assembly shown in FIG. 2, the wheel assembly shown in FIG. 3 additionally has a traction motor 14. The traction motor 14 is arranged substantially perpendicularly above the two individual wheels or a bogie 15 carrying the individual wheels, and in particular on a rotary shaft (not shown in more detail in the figures). The rotary shaft can be arranged substantially perpendicularly between the traction motor 14 and the wheel assembly 1, and serves to transmit a rotational movement from the traction motor 14 to the individual wheels of the wheel assembly 1 for driving the industrial truck 100. The axis of rotation of the traction motor 14 in the present case can substantially correspond to the axis of rotation of the aforementioned rotary shaft (not shown), which in the present case also corresponds to the steering axis A1. An orbital transmission can additionally be provided between the traction motor 14 or the rotary shaft and the steerable wheel 1. The traction motor 14 can be designed as a conventional motor of such industrial trucks and serves to drive the respective wheel 1 for driving the industrial truck 100.

A steering drive unit 3 is arranged laterally next to the steerable wheel 1. The steering drive unit 3 comprises a steering drive housing 7 which is fastened to the vehicle chassis 13 via a fastening device 10, in particular via a fastening flange. The steering drive unit 3 serves for the motorized steering of the steerable wheel 1 respectively assigned thereto, and has a rotary steering motor 4 arranged in the steering drive housing 7 therefor. On an upper side of the steering drive unit 3, a steering shaft 2 extends from the steering drive housing 7, so that the steering shaft 2 can also be referred to as the output shaft 11 of the rotary steering motor 4. The output shaft 11 in this case forms a steering drive axis A3, which in the present case coincides with the steering shaft axis A2 of the steering shaft 2.

The steering shaft 2 has a portion 20 via which the steering shaft 2 is operatively connected to the bogie 15 for rotating the bogie 15. In particular in the portion 20, a rotational movement of the steering shaft 2 can be transmitted to the bogie 15 of the wheel assembly 1 or a shaft connected thereto, for example, as in the present case, via a chain arrangement 16. A transmission 12, and in particular a transmission gearing, can additionally be provided therefor, as is here the case. This provides for a particularly reliable force transmission and particularly exact positioning and steering of the wheel assembly 1.

An arrangement is of course also in principle possible in which the steering drive unit 3 is arranged directly above a steerable wheel assembly 1. The steering shaft axis A2 of the steering shaft 2 can in this case correspond to the steering axis A1 of the steerable wheel 1.

The steering drive unit 3 comprises the rotary steering motor 4 for the motorized rotation of the steering shaft 2, and thus ultimately for steering the steerable wheels 1. The industrial truck 100 has a steering angle control 5 (which is not shown in greater detail) to control each rotary steering motor 4. The steering angle control 5 interacts functionally with each of the steering drive units 3 of the steerable wheels 1 in this case.

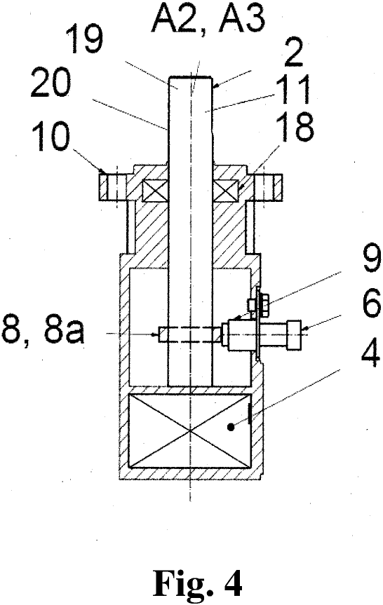

The steering drive unit 3 is shown in further detail in FIG. 4, whereby the steering drive housing 7 is not shown or is shown only in part for better clarity. FIG. 4 in particular shows only the fastening flange 10 of the steering drive housing 7. The steering drive unit 3 is fastened via the fastening flange 10 to a receiving device 17 of the vehicle chassis 13, and extends downwards towards the receiving device 17, in particular in the illustration in FIG. 4.

The rotary steering motor 4 is arranged in an end region, opposite the fastening device 10, of the steering drive unit 3. The rotary steering motor 4 can be designed as a hydraulic motor (in particular as an orbital motor) or as an electric motor. The rotary steering motor 4 can in particular be designed separately and fixed in or on the steering drive housing 7 (which is not shown in greater detail). The rotary steering motor 4 can therefore be replaced in a particularly simple and uncomplicated manner, in particular independently of further components of the steering drive unit 3.

The steering shaft 2 extends from the rotary steering motor 4 in longitudinal extension through the steering drive housing 7 (not shown), is mounted in a region spaced apart from the rotary steering motor 4 (in particular in the region of the fastening flange 10) via a drive-side bearing 18, and extends further, with a free end 19, up into the surroundings of the steering drive unit 3 (above the fastening flange 10 in FIG. 4). In the region of the free end 19, the portion 20 is provided, in which the above-explained force transmission from the steering shaft 2 to the bogie 15 takes place.

In order to enable a reliable operation and in particular an exact control of the respective rotary steering motor 4 of the industrial truck 100 via the steering angle control 5, each steering drive unit 3 comprises a rotational angle detection device 6 for detecting a current rotational angle position of the steering shaft 2. The steering angle control 5 can thereby provide information about the actual current rotational angle position of the steering shaft 2, and thus indirectly also about the actual current rotational angle position of the bogie 15 connected to the steering shaft 2. Via the steering angle control 5, the current rotational angle position of the bogie 15 can, for example, be determined by calculation on the basis of this information and, for controlling the rotary steering motor 4, a comparison of the current rotational angle position of the bogie 15 with a predetermined target value of the rotational angle position can take place.

According to the present invention, the rotational angle detection device 6 is designed as part of the steering drive unit 3, and is in particular integrated into the steering drive unit 3. The rotational angle detection device 6 is in the present case arranged within the steering drive housing 7, in particular, axially, between the drive-side bearing 18 and the rotary steering motor 4, and is completely surrounded by the steering drive housing 7. In this region, a certain space for a low-vibration mounting of the steering shaft 2 is present into which the rotational angle detection device 6 can be integrated in a space-saving manner.

The rotational angle detection device 6 comprises an encoder unit 8, which is connected in a rotationally-fixed manner to the steering shaft 2, and a sensor unit 9 which functionally interacts with the encoder unit 8.

The encoder unit 8 in the present case is designed as a magnet ring having several magnetic encoder elements 8a distributed over its circumference. The magnetic encoder elements 8a can in particular be designed as permanent magnets and have different poles over the circumference of the magnet ring 8, at least to the outside. This enables a particularly exact detection of the current rotational angle position of the steering shaft 2.

The sensor unit 9 is designed as a conventional magnetic sensor unit, e.g., as a Hall sensor, and serves to detect a magnetic field generated by the magnetic encoder element 8a. The sensor unit 9 is in this case fixed, i.e., arranged in a stationary manner with respect to the steering drive housing 7, and can in particular be fastened thereto. The sensor unit 9 can as a result be replaced quickly and in a particularly simple manner if necessary. Depending upon the accuracy requirement, sensor units 9 having different sensor systems can in particular be used, wherein the installation location and the installation type can be designed identically. This provides for a particularly cost-effective manufacture of the industrial truck 100.

It should be clear that the scope of protection of the present invention is not limited to the above-described embodiment. The arrangement of the steering drive unit with respect to the steerable wheel assembly can in particular be entirely modified without changing the core of the present invention. The longitudinal extension of the steering drive unit can, for example, be arranged laterally next to or in the steering axis of the wheel assembly. Reference should also be had to the appended claims.

LIST OF REFERENCE SIGNS

| | |
|---|---|
| 1, 1′, 1″, 1‴, 1⁗ | steerable wheel, wheel assembly |
| 2 | steering shaft |
| 3 | steering drive unit |
| 4 | rotary steering motor |
| 5 | steering angle control |
| 6 | rotational angle detection device |
| 7 | steering drive housing |
| 8 | encoder unit |
| 8 a | encoder element |
| 9 | sensor unit |
| 10 | fastening device / fastening flange |
| 11 | output shaft |
| 12 | transmission / transmission gearing |
| 13 | vehicle chassis |
| 14 | traction motor |
| 15 | bogie |
| 16 | chain arrangement |
| 17 | receiving device |
| 18 | drive-side bearing |
| 19 | free end (of steering shaft 2) |
| 20 | portion (operatively connecting steering shaft 2 to bogie 15 to rotate bogie 15) |
| 100 | industrial truck |
| A1 | steering axis |
| A2 | steering shaft axis |
| A3 | steering drive axis |

What is claimed is:

1-11. (canceled)

12. An industrial truck comprising:
at least two steerable wheels each of which is configured to be steerable independently of one another, each of the at least two steerable wheels having assigned thereto,
one steering drive unit which comprises a rotary steering motor, and
one steering shaft,
wherein, each one of the at least two steerable wheels is connected to the rotary steering motor of the steering drive unit via the steering shaft which is assigned thereto; and
a steering angle control which is configured to control each rotary steering motor, the steering angle control comprising at least one rotational angle detection device which is configured to detect a current rotational angle position of each steering shaft, wherein,
the at least one rotational angle detection device is designed as a part of each steering drive unit.

13. The industrial truck as recited in claim 12, wherein,
the steering angle control comprises a plurality of rotational angle detection devices,
one of the plurality of rotational angle detection devices is assigned to each steering shaft, and
each steering drive unit further comprises a steering drive housing which is arranged to surround the rotational angle detection device which is assigned to the steering shaft.

14. The industrial truck as recited in claim 13, wherein each of the plurality of rotational angle detection devices comprises,
an encoder unit which is connected in a rotationally-fixed manner to the steering shaft to which the respective rotational angle detection device is assigned, and
a sensor unit which is configured to functionally interact with the encoder unit.

15. The industrial truck as recited in claim 14, wherein,
the encoder unit comprises at least one magnetic encoder element, and
the sensor unit comprises at least one magnetic field sensor which is configured to detect the at least one magnetic encoder element.

16. The industrial truck as recited in claim 13, wherein,
each steering drive unit further comprises a fastening device, and
one of the plurality of rotational angle detection devices is arranged between each rotary steering motor and the fastening device of each steering drive unit, respectively.

17. The industrial truck as recited in claim 12, wherein,
each steering shaft has a steering shaft axis,
each steering drive unit has a steering drive axis,
each of the at least two steerable wheels has a steering axis, and
the steering shaft axis of each steering shaft corresponds to at least one of the steering drive axis of each steering drive unit and to the steering axis of each of the at least two steerable wheels.

18. The industrial truck as recited in claim 12, wherein,
each steering drive unit further comprises an output shaft, and
each steering shaft is formed by the output shaft of the steering drive unit.

19. The industrial truck as recited in claim 12, further comprising:
transmissions, wherein,
one of the transmissions is arranged between each steering drive unit and each of the at least two steerable wheels, respectively.

20. The industrial truck as recited in claim 12, wherein each rotary steering motor is designed as a hydraulic motor or as an electric motor.

21. The industrial truck as recited in claim 20, wherein the hydraulic motor is an orbital motor.

22. The industrial truck ass recited in claim 12, wherein each rotary steering motor is designed to be replaceable independently of the rotational angle detection device.
